(19) United States
(12) Patent Application Publication
(10) Pub. No.: US 2011/0065400 A1
(43) Pub. Date: Mar. 17, 2011

(54) INTEGRATED ANTENNA ARRAY AND RF FRONT END MODULE

(75) Inventors: Ilari Teikari, Helsinki (FI); Antti Kainulainen, Espoo (FI)

(73) Assignee: Nokia Corporation

(21) Appl. No.: 12/992,594

(22) PCT Filed: May 11, 2009
(86) PCT No.: PCT/IB09/05556

§ 371 Date: Nov. 12, 2010

(30) Foreign Application Priority Data
May 12, 2008 (GB) 0808574.8

(51) Int. Cl. H04B 1/04

(52) U.S. Cl. 455/129

(57) ABSTRACT

Apparatus comprising an antenna switch (601) configured to select at least one antenna; and a controller (205b). The controller is configured to control the antenna switch in a first mode of operation and a second mode of operation. The first mode of operation is where the apparatus is configured to communicate with a further apparatus. The second mode of operation is where the apparatus is configured to perform a direction finding.

### BACKGROUND OF THE INVENTION

The present invention relates to an apparatus, and in particular to apparatus for providing a service in a communication system.

### DESCRIPTION OF RELATED ART

A communication device can be understood as a device provided with appropriate communication and control capabilities for enabling use thereof for communication with others parties. The communication may comprise, for example, communication of voice, electronic mail (email), text messages, data, multimedia and so on. A communication device typically enables a user of the device to receive and transmit communication via a communication system and can thus be used for accessing various service applications.

A communication system is a facility which facilitates the communication between two or more entities such as the communication devices, network entities and other nodes. A communication system may be provided by one or more interconnect networks. One or more gateway nodes may be provided for interconnecting various networks of the system. For example, a gateway node is typically provided between an access network and other communication networks, for example a core network and/or a data network.

An appropriate access system allows the communication device access to the wider communication system. An access to the wider communications system may be provided by means of a fixed line or wireless communication interface, or a combination of these. Communication systems providing wireless access typically enable at least some mobility for the users thereof. Examples of these include wireless communications systems where the access is provided by means of an arrangement of cellular access networks. Other examples of wireless access technologies include different wireless local area networks (WLANs) and satellite based communication systems.

A wireless access system typically operates in accordance with a wireless standard and/or with a set of specifications which set out what the various elements of the system are permitted to do and how that should be achieved. For example, the standard or specification may define if the user, or more precisely user equipment, is provided with a circuit switched bearer or a packet switched bearer, or both. Communication protocols and/or parameters which should be used for the connection are also typically defined. For example, the manner in which communication should be implemented between the user equipment and the elements of the networks and their functions and responsibilities are typically defined by a predefined communication protocol.

In the cellular systems a network entity in the form of a base station provides a node for communication with mobile devices in one or more cells or sectors. It is noted that in certain systems a base station is called ‘Node B’. Examples of cellular access systems include Universal Terrestrial Radio Access Networks (UTRAN) and GSM (Global System for Mobile) EDGE (Enhanced Data for GSM Evolution) Radio Access Networks (GERAN).

A non-limiting example of another type of access architectures is a concept known as the Evolved Universal Terrestrial Radio Access (E-UTRA). This is also known as Long term Evolution UTRA or LTE. An Evolved Universal Terrestrial Radio Access Network (E-UTRAN) consists of E-UTRAN Node Bs (eNBs) which are configured to provide base station and control functionalities of the radio access network. The eNBs may provide E-UTRA features such as user plane radio link control/medium access control/physical layer protocol (RLC/MAC/PHY) and control plane radio resource control (RRC) protocol terminations towards the mobile devices.

The relative size of the communication device or handset in such a communication system raises problems for the placement of an antenna array on the communication device which is able to perform such tasks as direction finding (DF), transmit/receive diversity, or multiple input multiple output (MIMO) operations.

An antenna array for example may be employed in direction finding devices capable of transmitting suitable radio frequency signals. The use of antenna array configurations are for example suitable for finding objects which do not require preknowledge of what the handset with the antenna array is to seek. For example, locating a wallet or another user with RF transmission capabilities may be carried out by a handset with an antenna array. However the array configuration is difficult to implement in a single handheld device because of the maximum distance between antennas is small.

The conventional communication device such as the mobile terminal or user equipment has many components in addition to the antenna, for example a communication device may also have a display and the ground plane of a printed circuit board which limits the number and location of the array elements. The typical communication device may in use also be limited by its operation, for example the hand of the user may shadow the antenna array element causing the antenna performance to deteriorate significantly.

One method to overcome this is to place the antenna array far from the transceiver circuitry on the communication device which furthermore causes problems relating to connecting the antenna array to the transceiver.

For example one such problem is that typically each antenna is configured to be initially connected to a balun so that the differential output produced from each antenna element is converted into a suitable single side output which may then be processed by the transceiver element located away from the antenna elements. Such a configuration is problematic in that it is complex to produce and the output from each element would differ due to manufacturing tolerances in the balun attached to each antenna element.

Furthermore typical direction finding capability is implemented within the communication device by implementing two parallel systems which may be controlled centrally do not interact. Such devices are typically bulky as they have to implement a large number of similar devices in order that the device may be both operated as a communication device and yet have the ability to carry out searching.

### SUMMARY

Embodiments of the present invention aim to address one or at least partially mitigate the above problems.

According to a first aspect of the invention there is provided an apparatus comprising: an antenna switch configured to select at least one antenna; and a controller configured to control the antenna switch in a first mode of operation wherein the apparatus is configured to communicate with a further apparatus, and a second mode of operation wherein the apparatus is configured to perform a direction finding.

The apparatus may further comprise: a transceiver configured to be connected to the antenna switch and configured to generate output signals and decode input signals.

The apparatus may further comprise an antenna array comprising at least two antennas, wherein the controller is preferably configured in the second mode of operation to control the antenna switch to sequentially switch each antenna to the amplifier.

The controller is preferably configured in the first mode of operation to control the antenna switch to connect only one antenna to the amplifier.

The controller may comprise a counter configured to be connected to the antenna switch and output an antenna selection signal, wherein the antenna switch selects at least one antenna dependent on the antenna selection signal value.

The controller may further comprise a state machine logic configured to output a count signal to the counter, wherein the counter preferably increments the antenna selection signal value dependent on the count signal.

The controller may further comprise a state machine logic configured to output a reset signal to the counter, wherein the counter preferably resets the antenna selection signal value dependent on the count signal.

The controller may be further configured to operate the apparatus in an input only mode, wherein signals are preferably input from the antenna switch to the transceiver, and an output only mode, wherein the signals are preferably output from the transceiver to the antenna switch.

The transceiver may comprise a low noise amplifier and a power amplifier, wherein the controller is preferably configured to operate the low noise amplifier in the input only mode and operate the power amplifier in the output only mode.

The antenna switch may comprise at least one of: a balanced antenna switch; and a single ended antenna switch.

According to a second aspect of the invention there is provided a method comprising: selecting at least one antenna for connection with an at least one input and output signal; and controlling the and selecting in a first mode of operation to communicate using the signals, and a second mode of operation to perform a direction finding dependent on the signals.

The method may further comprise: generating output signals; and decoding input signals.

Controlling in the second mode of operation may control the selecting to sequentially select each antenna.

Controlling in the first mode of operation may control the selecting to select only one antenna.

The controlling may comprise: counting a number of clock signals; and outputting an antenna selection signal dependent on the counted number of clock signals, and the selecting may comprise selecting the at least one antenna dependent on the antenna selection signal value.

The controlling may further comprise controlling the counting of the clock signals.

The controlling may comprise controlling the counting of the clock signals by outputting a reset signal, wherein the counting resets the antenna selection signal dependent on the reset signal value.

The controlling is preferably further configured to select only the at least one output signal.

The apparatus as described above may comprise a user equipment.

The apparatus as described above may comprise a chipset.

According to a third aspect of the invention there is provided a computer program product configured to perform a method comprising: selecting at least one antenna for connection with the at least one input and output signal; and controlling the selecting in a first mode of operation to communicate using the signals, and a second mode of operation to perform a direction finding dependent on the signals.

According to a fourth aspect of the invention there is provided an apparatus comprising: means for selecting at least one antenna for connection; means for controlling the antenna switch in a first mode of operation wherein the apparatus is configured to communicate the signals with a further apparatus, and a second mode of operation wherein the apparatus is configured to perform a direction finding dependent on the signals.

According to a fifth aspect of the invention there is provided apparatus comprising a first transceiver configured to generate and receive signals using a first communications protocol; a second transceiver configured to generate and receive signals using a second communications protocol; an antenna switch configured to select at least one antenna from at least two antennas for connection to either the first or second transceiver; and a controller configured to control the antenna switch in a first mode of operation wherein the antenna switch is configured to connect the at least one of the antenna to the first transceiver, and a second mode of operation wherein the antenna switch is configured to select the at least one of the antenna to connect to the second transceiver.

The first mode of operation is preferably for communication with a further apparatus,

The second mode of operation is preferably for direction finding operations.

The antenna switch may comprise: a first antenna switch configured to select one of a first set of antennas; and a second antenna switch configured to select either the first antenna switch or one of a second set of antennas.

The first transceiver may comprise a wireless local area network transceiver.

The second transceiver may comprise a Bluetooth transceiver.

According to a sixth aspect of the invention there is provided a method comprising: generating and receiving signals using a first communications protocol; generating and receiving signals using a second communications protocol; selecting at least one antenna from at least two antennas for connection to either the first or second communication protocol signals; and controlling the antenna switch in a first mode of operation wherein the antenna switch is configured to connect the at least one of the antenna to the first communication protocol signals, and a second mode of operation wherein the antenna switch is configured to select the at least one of the antenna to connect to the second communication protocol signals.

The first mode of operation is preferably for communication with a further apparatus,

The second mode of operation is preferably for direction finding operations.

The selecting may comprise: selecting one of a first set of antennas; and selecting either the selected one of a first set of antennas or one of a second set of antennas.

For a better understanding of the present invention and how the same may be carried into effect, reference will now be made by way of example only to the accompanying drawings in which:

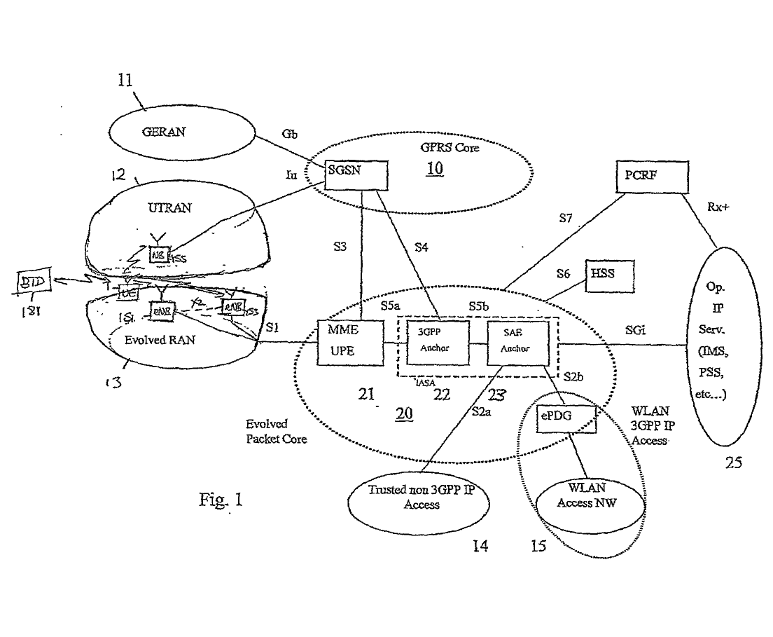

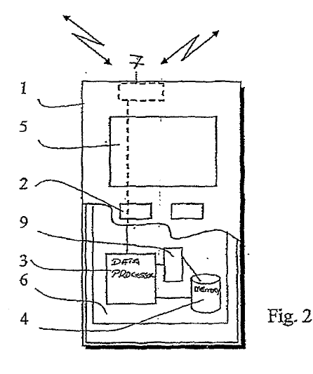

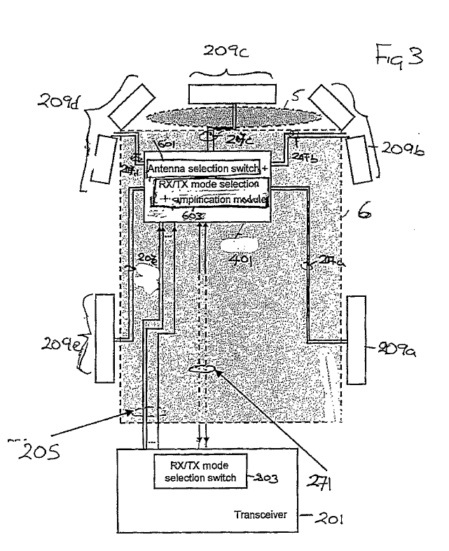

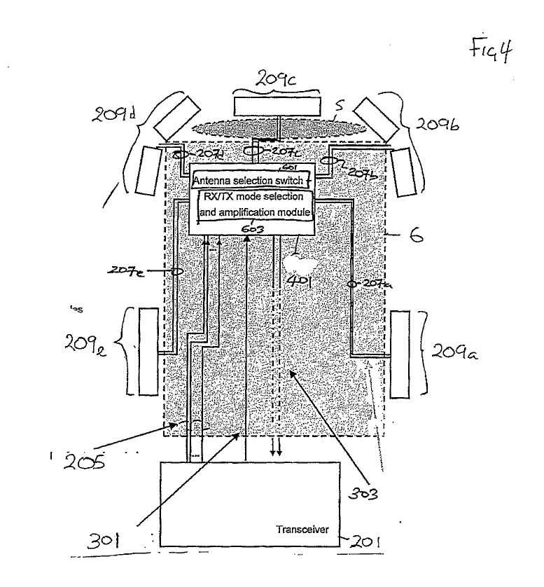

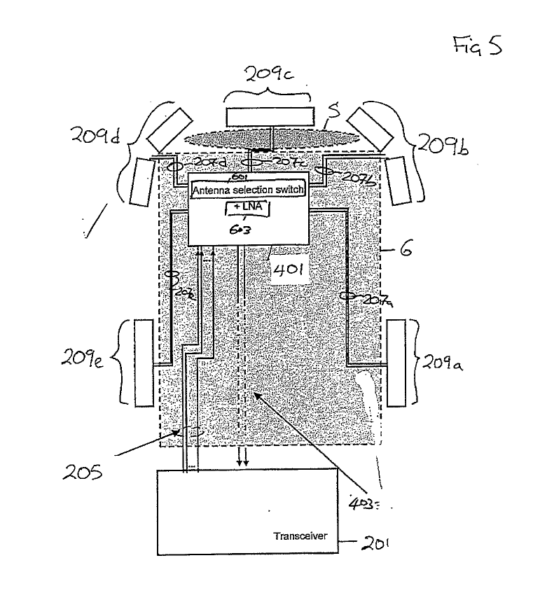

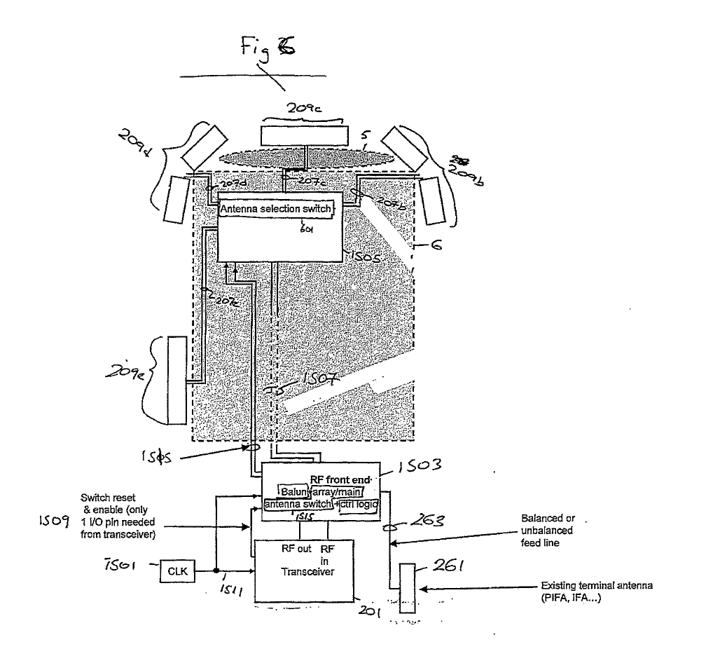

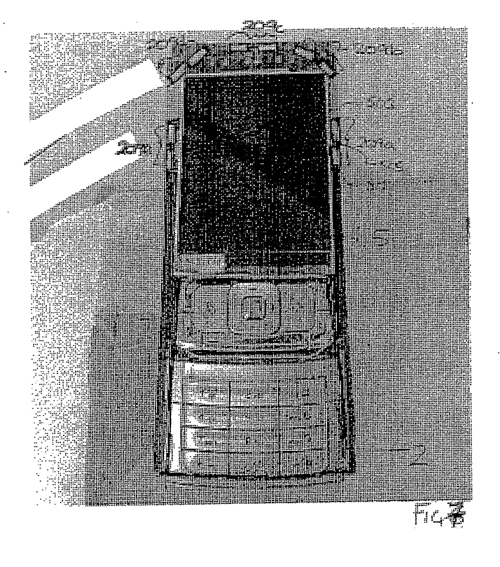

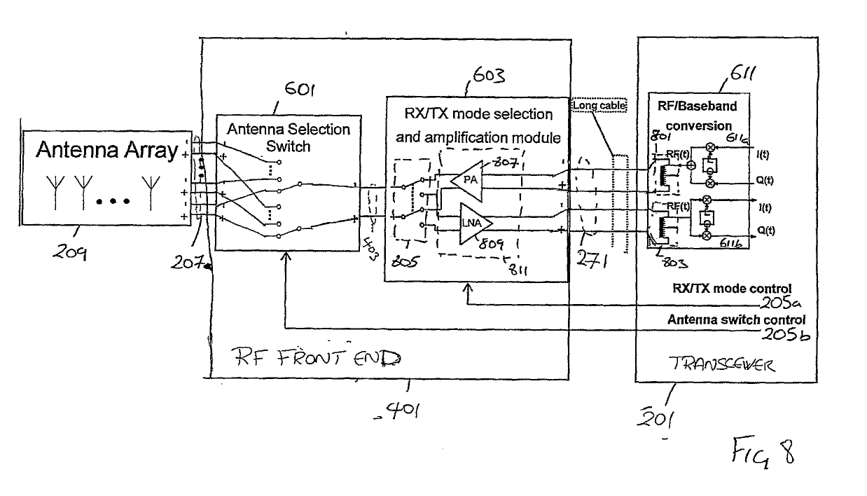

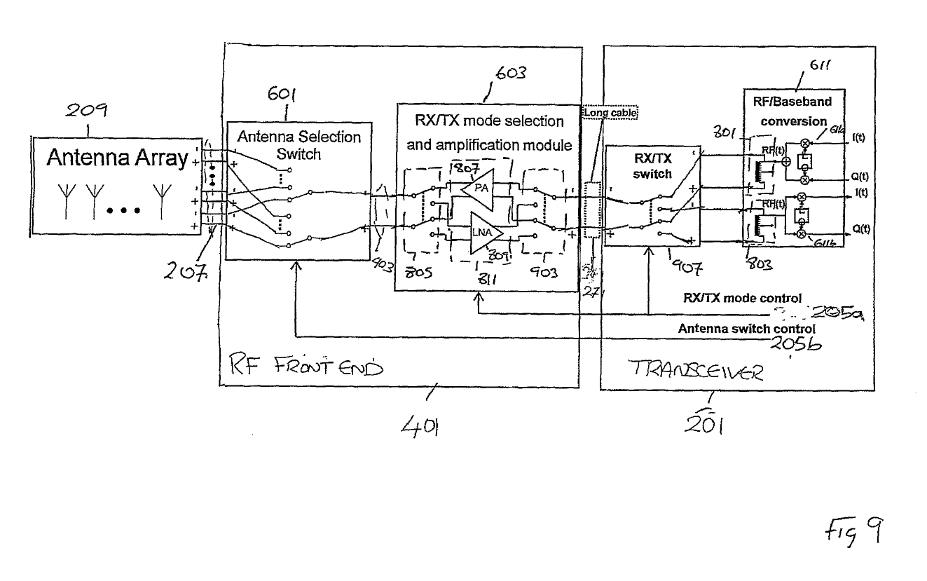

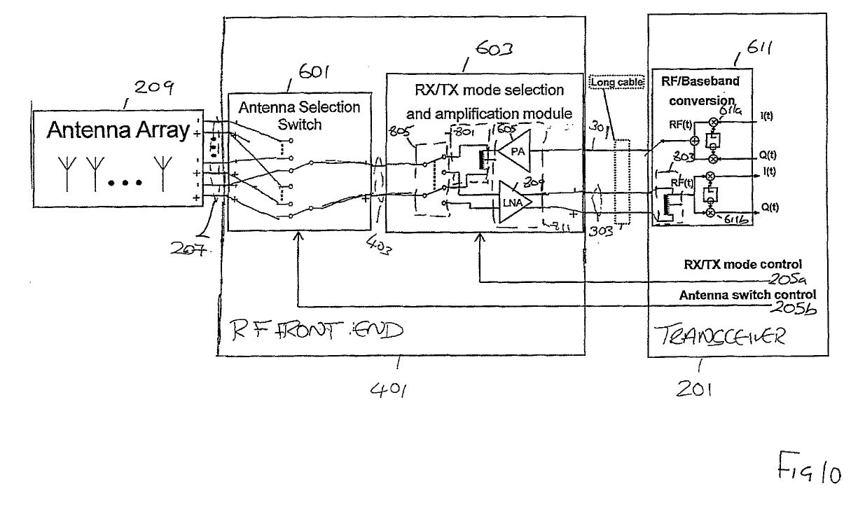

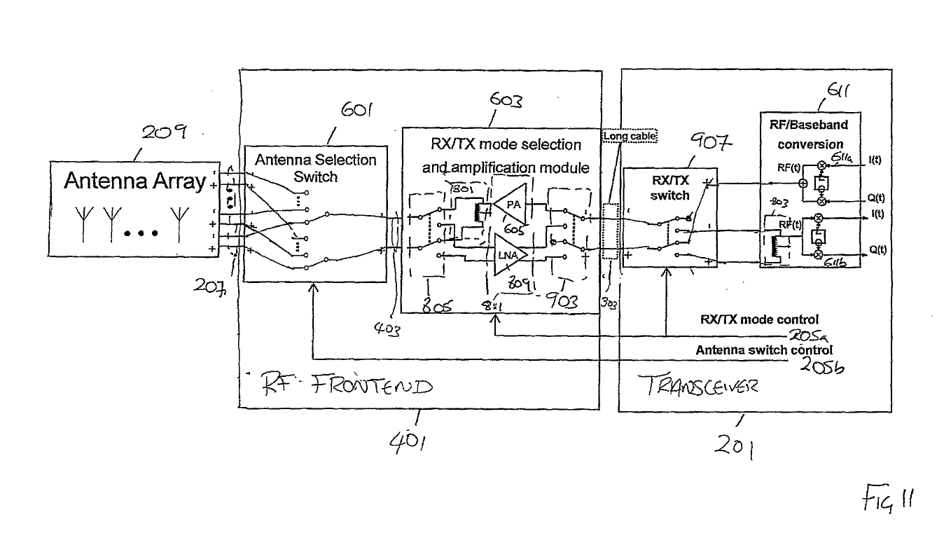

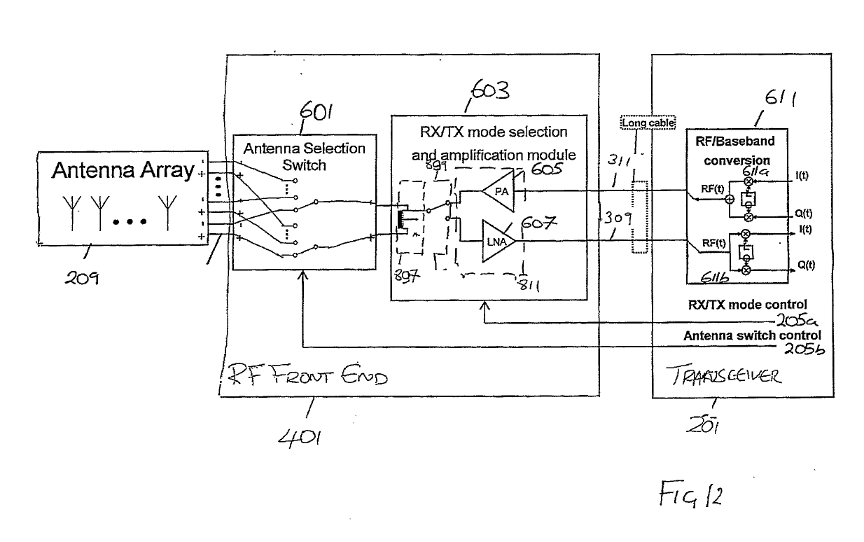

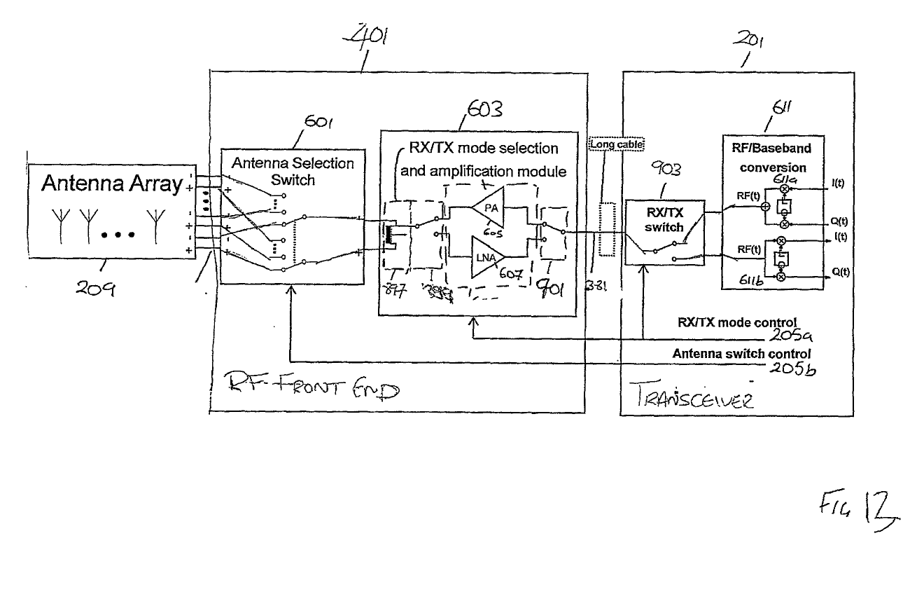

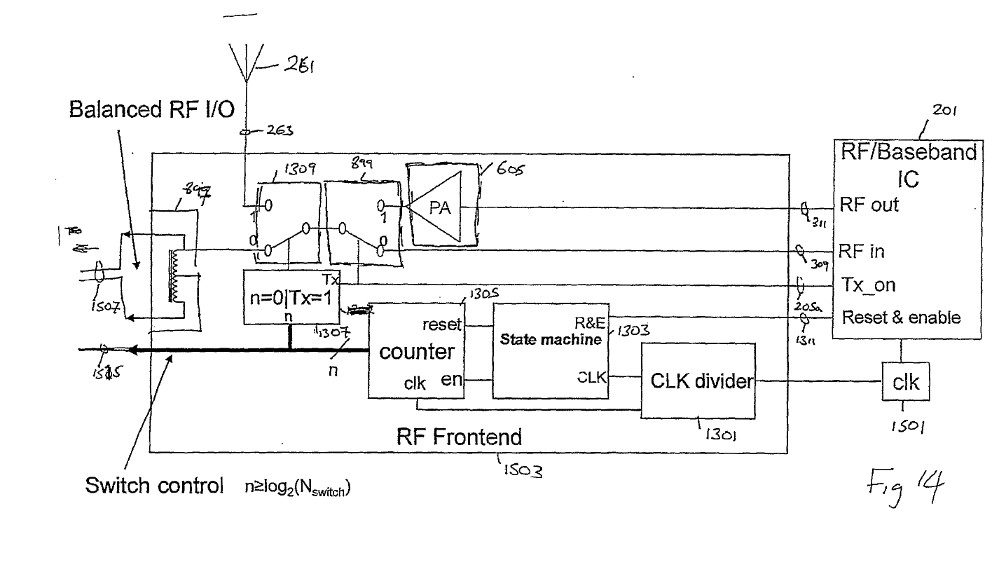

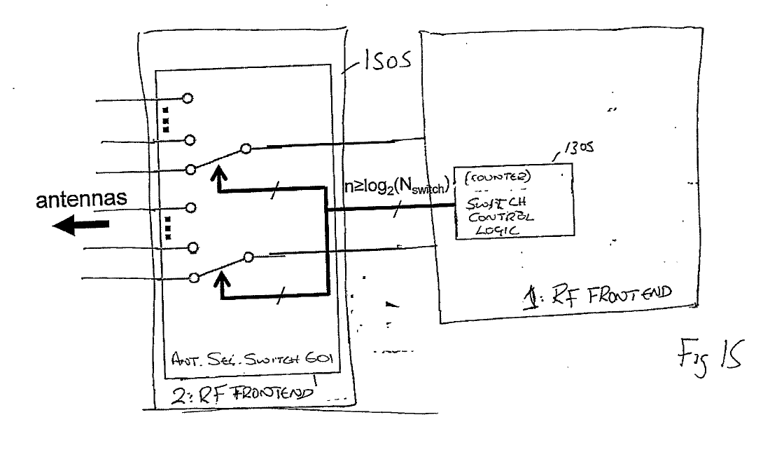

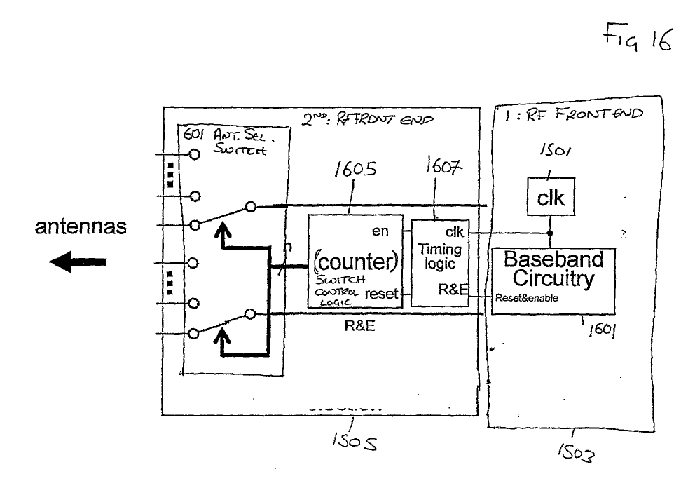

FIG. 1 shows a schematic presentation of a communication architecture wherein the invention may be embodied;

FIG. 2 shows a schematic presentation of an user equipment which may be operated in the communication architecture as shown in FIG. 1;

FIG. 3 shows a schematic presentation of an user equipment which may be operated in the communication architecture as shown in FIG. 1 encompassing an embodiment of the invention;

FIG. 4 shows a schematic presentation of an user equipment which may be operated in the communication architecture as shown in FIG. 1 encompassing a further embodiment of the invention;

FIG. 5 shows a schematic presentation of an user equipment which may be operated in the communication architecture as shown in FIG. 1 encompassing a further embodiment of the invention;

FIG. 6 shows a schematic presentation of an user equipment which may be operating in the communication architecture as shown in FIG. 1 encompassing a further embodiment of the invention;

FIG. 7 shows an example antenna arrangement in an user equipment such as shown in FIGS. 2 to 6;

FIG. 8 shows a schematic circuit arrangement in the user equipment showing a differential implementation embodiment;

FIG. 9 shows a schematic circuit arrangement in the user equipment showing a differential with shared interconnect implementation embodiment;

FIG. 10 shows a schematic circuit arrangement in the user equipment showing a single ended/differential implementation embodiment;

FIG. 11 shows a schematic circuit arrangement in the user equipment showing a single ended/differential with shared interconnect implementation;

FIG. 12 shows a schematic circuit arrangement in the user equipment showing a single ended implementation embodiment;

FIG. 13 shows a schematic circuit arrangement in the user equipment showing a single ended with shared interconnect implementation embodiment;

FIG. 14 shows schematically a circuit arrangement implementation in the user equipment according to embodiments of the invention;

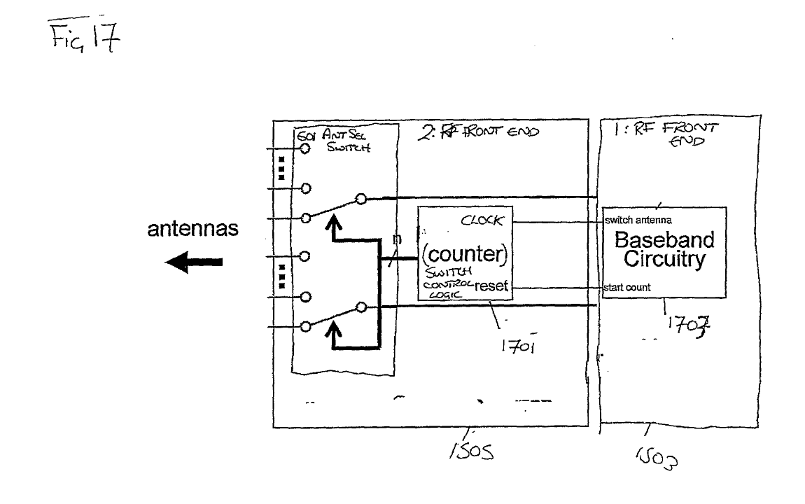

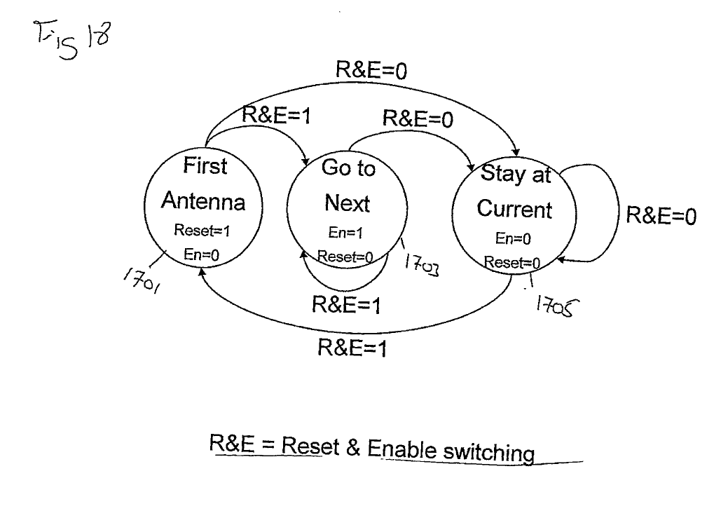

FIG. 15 shows schematically a parallel circuit arrangement of the antenna selection switch according to embodiments of the invention;

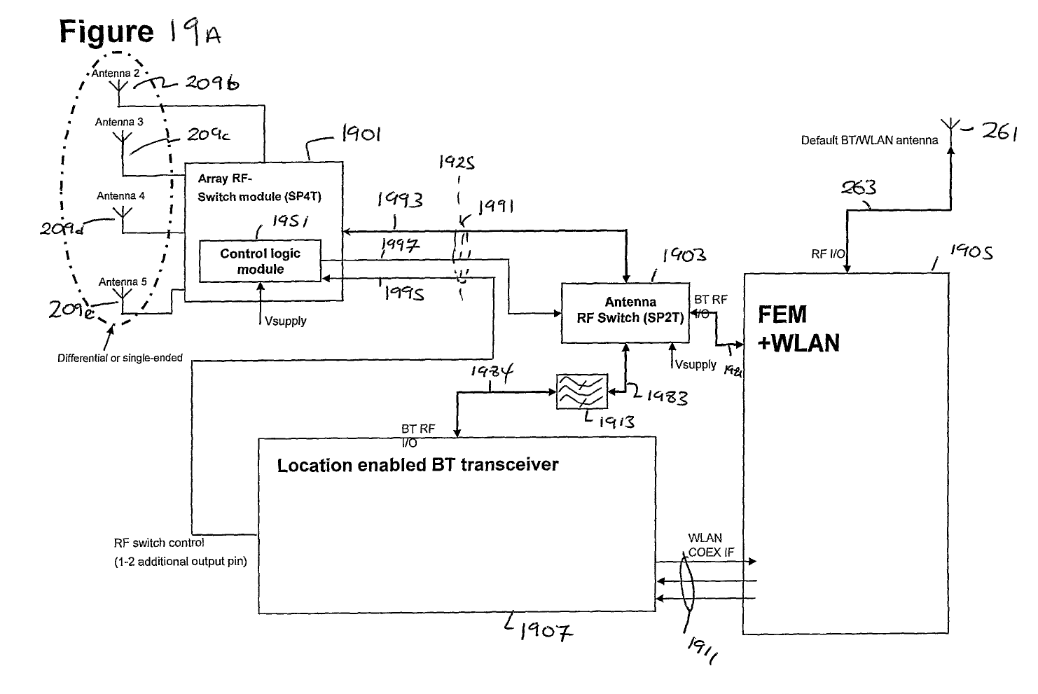

FIG. 16 shows schematically a serial circuit arrangement of the antenna selection switch according to embodiments of the invention;

FIG. 17 shows schematically a further serial circuit arrangement of the antenna selection switch according to embodiments of the invention;

FIG. 18 shows schematically a control mechanism for operating the antenna selection switch according to embodiments of the invention;

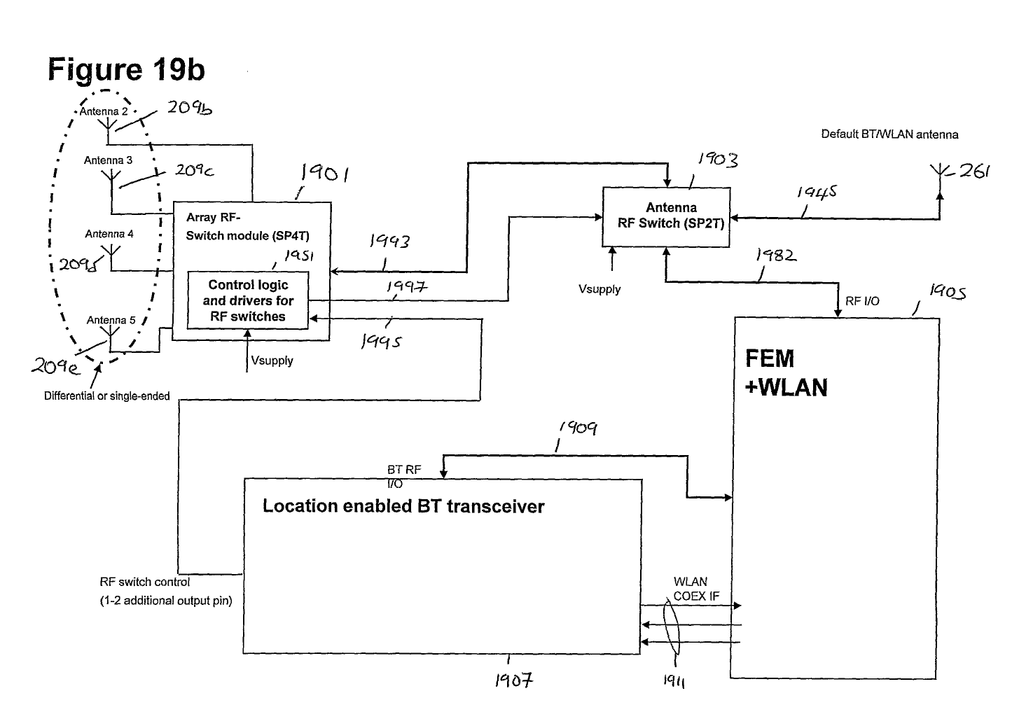

FIGS. 19a and 19b show schematically circuit configurations encompassing further embodiments of the invention;

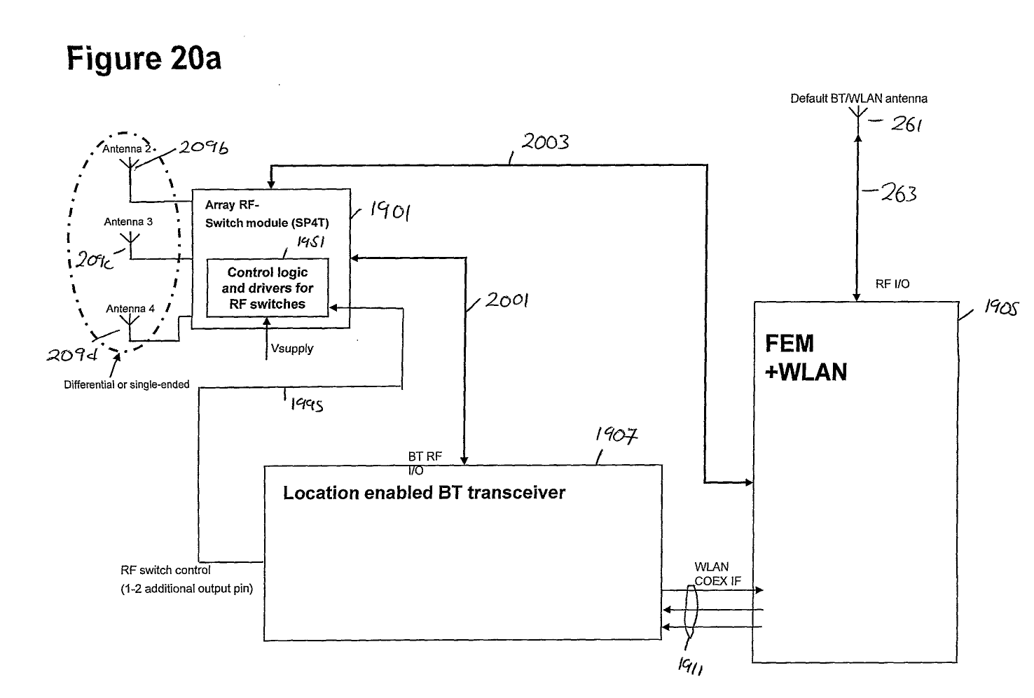

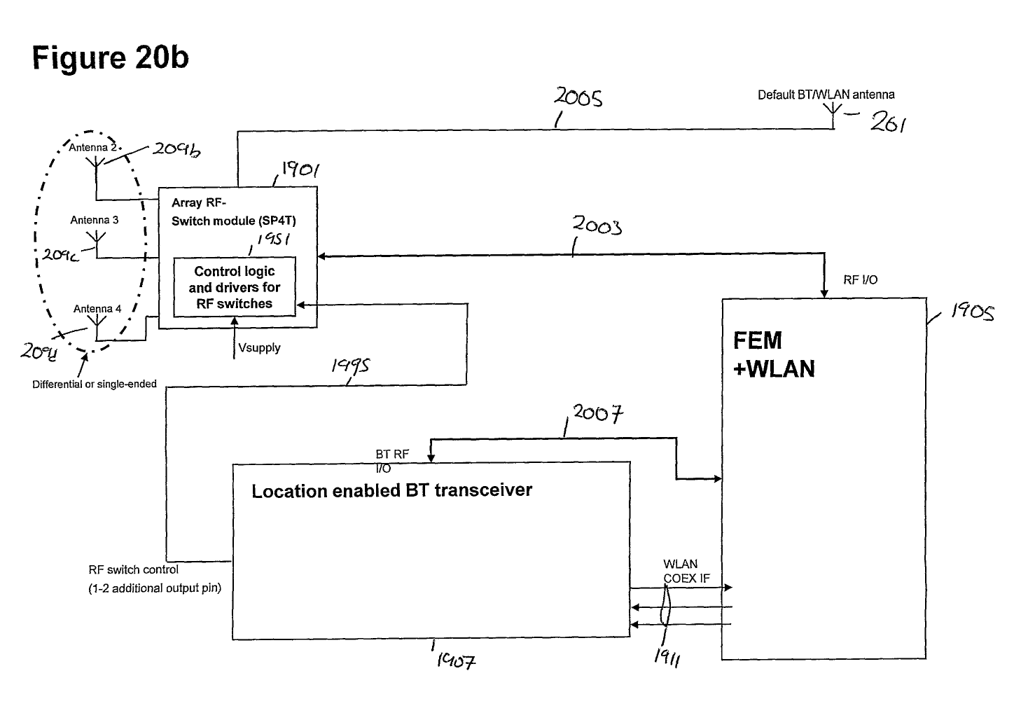

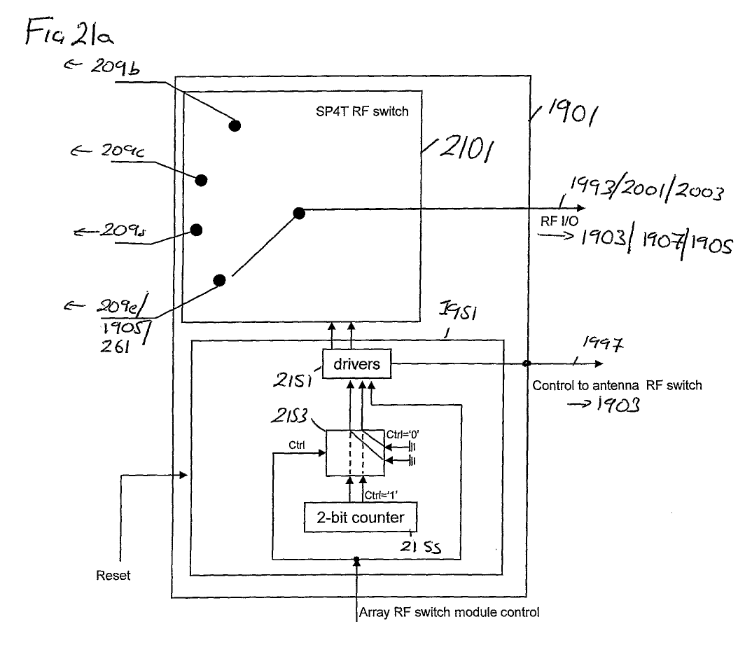

FIGS. 20a and 20b show schematically further circuit configurations encompassing further embodiments of the invention;

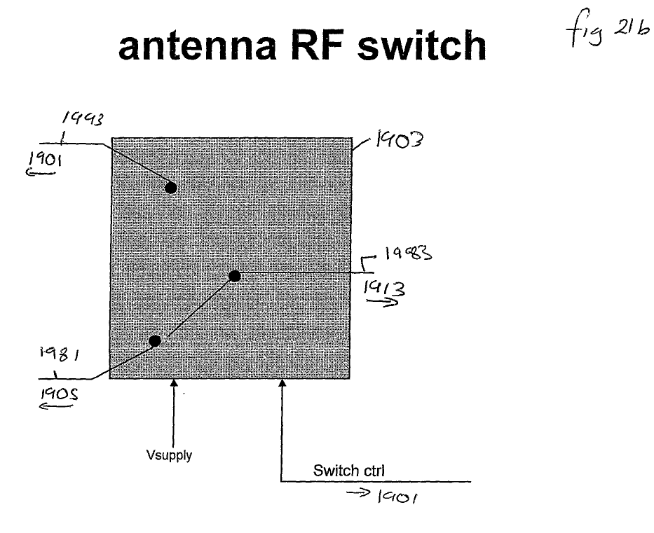

FIG. 21a shows schematically an array radio frequency switch module as shown in FIGS. 19a, 19b, 20a and 20b;

FIG. 21b shows schematically an antenna radio frequency switch as shown in FIGS. 19a and 19b; and

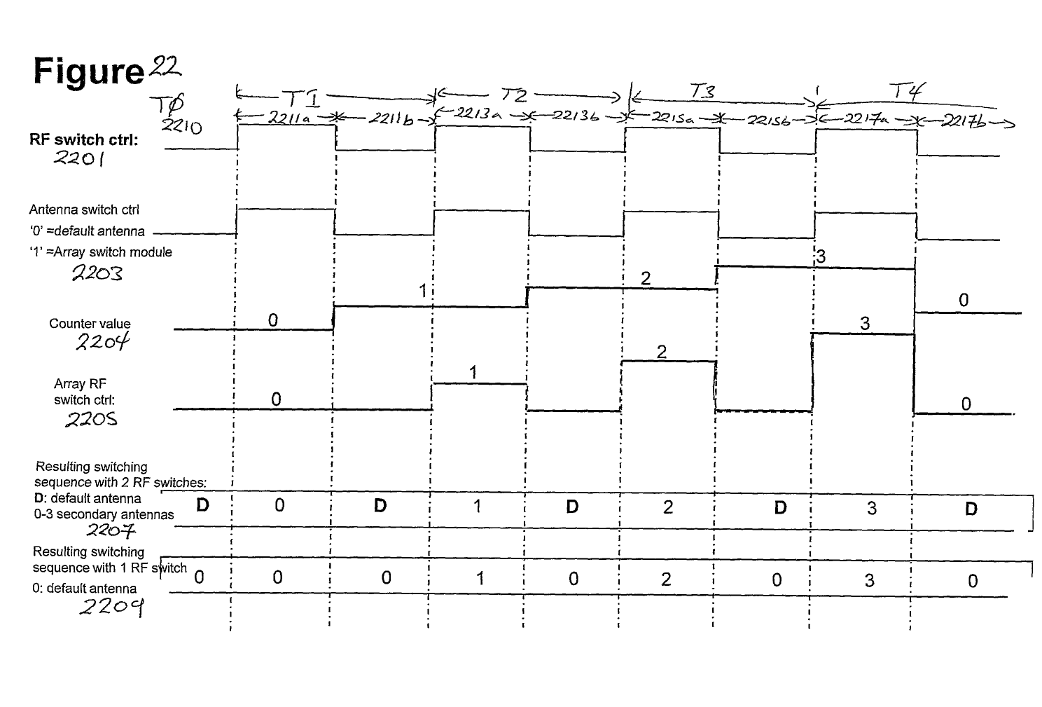

FIG. 22 shows examples of control signal waveforms and antenna selection for the embodiments shown in FIGS. 19a, 19b, 20a and 20b.

### DESCRIPTION OF THE EXEMPLIFYING EMBODIMENTS

In the following certain specific embodiments are explained with reference to standards such as Global System for Mobile (GSM) Phase 2, Code Division Multiple Access (CDMA) Universal Mobile Telecommunication System (UMTS) and long-term evolution (LTE). The standards may or not belong to a concept known as the system architecture evolution (SAE) architecture, the overall architecture thereof being shown in FIG. 1. However although the below examples are described with reference to user equipment, it would be appreciated by the person skilled in the art that the inventive concept expressed in various embodiments below may be implemented within a range of apparatus where it is desired to reduce the complexity of the transmitter/receiver elements, for example within direction finding electronic apparatus.

More particularly, FIG. 1 shows an example of how second generation (2G) access networks, third generation (3G) access networks and future access networks, referred to herein as long-term evolution (LTE) access networks are attached to a single data anchor (3GPP anchor). The anchor is used to anchor user data from 3GPP and non-3GPP networks. This enables adaptation of the herein described mechanism not only for all 3GPP network access but as well for non-3GPP networks.

In FIG. 1 two different types of radio access networks 11 and 12 are connected to a general packet radio service (GPRS) core network 10. The access network 11 is provided by a GERAN system and the access network 12 is provided by a UMTS terrestrial radio access (UTRAN) system. The UTRAN access network 11 is provided by a series of UTRAN Node Bs of which one Node B NB 155 is shown. The core network 10 is further connected to a packet data system 20.

An evolved radio access system 13 is also shown to be connected to the packet data system 20. Access system 13 may be provided, for example, based on architecture that is known from the E-UTRA and based on use of the E-UTRAN Node Bs (eNodeBs or eNBs) of which two eNBs 151 and 153 are shown in FIG. 1. The first eNB 151 is shown to be capable of communicating to the second eNB 153 via a X2 communication channel.

Access system 11, 12 and 13 may be connected to a mobile management entity 21 of the packet data system 20. These systems may also be connected to a 3GPP anchor node 22 which connects them further to a SAE anchor 23.

FIG. 1 shows further two access systems, that is a trusted non-3 Gpp IP (internet protocol) access system 14 and a WLAN access system 15. These are connected directly to the SAE anchor 23.

In FIG. 1 the service providers are connected to a service provider network system 25 connected to the anchor node system. The services may be provided in various manners, for example based on IP multimedia subsystem and so forth.

The various access networks may provide an overlapping coverage for suitable user equipment 1. For example the user equipment 1 as shown in FIG. 1 is shown being capable of communicating via the first eNB 151 in the SUTRA Network 13 and also the NB 155 of the UTRAN 12.

FIG. 1 further shows that the user equipment or apparatus 1 may further communicate to a Bluetooth enabled device (BTD) 181. The Bluetooth enabled device may be any apparatus configured to transmit and/or receive Bluetooth signals. In other embodiments of the invention the Bluetooth enabled device 181 is a ultra low power Bluetooth device or a similar low power wireless communications enabled device.

FIG. 2 shows a schematic partially sectioned view of a possible user equipment, also known as a mobile device 1 that can be used for accessing a communication system via a wireless interface provided via at least one of the access systems of FIG. 1 and suitable for employing embodiments of the invention. The user equipment (UE) of FIG. 2 can be used for various tasks such as making and receiving phone calls, for receiving and sending data from and to a data network and for experiencing, for example, multimedia or other content.

An appropriate user equipment may be provided by any device capable of at least sending or receiving radio signals. Non-limiting examples include a mobile station (MS), a portable computer provided with a wireless interface card or other wireless interface facility, personal data assistant (PDA) provided with wireless communication capabilities, or any combinations of these or the like. The mobile device may communicate via an appropriate radio interface arrangement of the mobile device. The interface arrangement may be provided for example by means of a radio part 7 and associated antenna arrangement which are described in further detail below with reference to FIGS. 3 to 12. The antenna arrangement may be arranged internally or externally to the mobile device.

A user equipment is typically provided with at least one data processing entity 3 and at least one memory 4 for use in tasks it is designed to perform. The data processing and storage entities can be provided on an appropriate circuit board and/or in chipsets. This feature is denoted by reference 6.

The user may control the operation of the user equipment by means of a suitable user interface such as key pad 2, voice commands, touch sensitive screen or pad, combinations thereof or the like. A display 5, a speaker and a microphone are also typically provided. Furthermore, the user equipment may comprise appropriate connectors (either wired or wireless) to other devices and/or for connecting external accessories, for example hands-free equipment, thereto.

The user equipment 1 may be enabled to communicate with a number of access nodes, for example when it is located in the coverage areas of either of the access system stations 12 and 13 of FIG. 1.

With respect to FIGS. 3 to 5, a series of schematic arrangements of antennas is shown according to embodiments of the invention. The architecture of the antenna array with an integrated radio frequency front-end suitable for handheld implementation, for example within a user equipment is described. The antenna array may be used for direction finding. However the antenna array elements may also be utilised as the transmit or receive antennas for normal data transmission. The antenna array and the integrated radio frequency front-end may be shared between different radio technologies operating at the same or similar band frequencies. For example, the antenna array may be implantation so that it is capable of using both Bluetooth and wireless local area network (WLAN) processes. Furthermore the embodiment of the array may also be utilised as a part of a multiple input multiple output antenna array.

With respect to FIGS. 3 to 5 the user equipment 1 radio part 7 and antenna configuration is shown in further detail.

With respect to FIG. 3, an embodiment of the invention is shown and in particular the configuration of an antenna array 209 and the radio part 7. In this embodiment the radio part 7 may be considered to comprise a radio frequency front end 401 and transceiver 201.

FIG. 3 also shows some of the other components of the user equipment 1 as shown in FIG. 2. For example the display 5 and circuit board 6 are shown symbolically. Other possible functional parts of a user equipment 1, which do not assist in the understanding of the invention such as a camera, loud speaker are not shown.

In the embodiment shown in FIG. 3, the antenna array comprises five separate antenna elements. The first antenna element 209a is configured to be connected to the RF front end 401 via a balanced feed line 207a which is used for both receive and transmit functionality. The balanced feed line 207a provides a differential path for transmitting and receiving signals between the first antenna element 209a and the RF front end 401. Furthermore the second antenna element 209b, the third antenna element 209c, the fourth antenna element 209d and the fifth antenna element 209e are similarly configured to be connected to the RF front end 401 via a second to fifth balanced feed line 207b, 207c, 207d, 207e respectively. The antenna array 209 may be used for both receive and transmit functionality.

The RF front end 401 comprises an antenna selection switch 601 and a receiver/transmitter selection and amplification module 603, the configuration and operation of which are described in further detail with respect to FIGS. 8 to 13

The RF front end 401 is configured to receive control signals via at least one control line 205 and furthermore to communicate data to and from the transceiver 201 via the balanced feed line 271. In a first embodiment of the invention as is described in further detail with respect to FIG. 8 there is provided a transmission path balanced feed line pair and a reception path balanced feed line pair. In a further embodiment of the invention as is described in further detail with respect to FIG. 8 and shown in FIG. 3 a single balanced feed line pair is used for both the transmission and reception path.

The transceiver 201 comprises a receiver/transmitter mode selection switch 803. The operation of which is further described in further detail in FIG. 9.

The transceiver 201 is configured to exchange transmitter and receiver data with the RF front end 401 via the shared balanced feed line 271. Furthermore the transceiver is further configured to provide the control signals for controlling the RF front end 401 onto the at least one control line 205.

With respect to FIG. 4 a further embodiment of the invention is shown where the transmission path between the transceiver 201 and the RF front end is implemented by the use of an unbalanced (or single ended) feed line 301 and the reception path between the RF front end 401 and the transceiver 201 is handled by a balanced (or differential) feed line pair 303. This embodiment is shown and described in further detail with respect to FIG. 10. A shared feed line embodiment is also described in further detail with respect to FIG. 11.

Furthermore although not shown in FIG. 4 but described in further detail with reference to FIGS. 12 and 13 below a further embodiment of the invention may be where the transmission path between the transceiver and the RF front end is implemented by the use of an unbalanced (or single ended) feed line and the reception path between the RF front end and the transceiver is handled by a unbalanced (or single ended) feed line. This embodiment is shown and described in further detail with respect to FIG. 12. A shared feed line embodiment is also described in further detail with respect to FIG. 13.

With respect to FIG. 5, a receiver only embodiment is shown. This may be considered to be similar to the embodiment shown in FIG. 3 but without the transmitter elements, such as a transmitter power amplifier, or the transmission/reception selection elements.

FIG. 5 differs from the configuration of as shown in FIG. 3 and described above in that the data connection between the radio frequency front-end 401 and the transceiver 201 is implemented by a balanced receiver feed line pair 403 from the radio frequency front-end 401 to the transceiver 201.

Furthermore the embodiment of FIG. 5 differs from the embodiment described with reference to FIG. 3 in that the receiver/transmitter mode selection and amplifier module 603 only comprises a low noise amplifier and the transceiver does not require a receiver or transmitter mode selection switch as there is no need to switch between receiver and transmitter modes of operation.

Similar receiver only or transmitter only embodiments of the invention may similarly be implemented using selected parts of the embodiments described above.

With respect to FIG. 6 a further embodiment of the invention is shown. In this embodiment of the invention the radio frequency front end is divided into two parts. A first part of the radio frequency front end 1503 receives the radio frequency input and output from the transceiver 201. Furthermore the transceiver and the first part of the radio frequency front end 1503 receives a clock signal on a clock line 1511 from a clock generator 1501. The first part of the radio frequency front end 1503 furthermore receives a switch reset and enables signal via a switch reset and enable feed 1509. The switch reset and enable signal is passed from the transceiver 201 to the first part of the radio frequency front end 1503.

The first part of the radio frequency front end transmits and receives via a balanced or unbalanced feed line 263 in an existing terminal antenna 261. The existing terminal antenna 261 may be a Planar Inverted F-type Antenna (PIFA), or Inverted F-type antenna (WA) configuration.

The radio frequency front end may comprise the components such as balun and an array/main antenna switch 1515 and control logic. The first part of the radio front end communicates to the second part of the radio frequency front end 1505. The second part of the radio frequency front end 1505 is configured to communicate with the antenna array which is shown as a four element array. Thus the second part of the radio frequency front end communicates to a second antenna element 209b via the balanced feed 209b, the third antenna element 209c via the balanced feed 207c, the fourth antenna element 209d via the balanced element 207d and the fifth antenna element 209e via the balanced element 207e. Furthermore the first and second radio frequency front end parts communicate via a pair of balanced feeds 1507. Furthermore the radio frequency front end first part 1503 can control the second part of the radio frequency front end 1505 via a series of control feeds 1505.

In some embodiments of the invention the existing terminal antenna is a Bluetooth (BT), Wireless Local Area Network (WLAN) or the antenna of the wireless cellular communications system. The use of the existing terminal antenna enables one less antenna element of the array of N elements. The existing terminal antenna can therefore in embodiments of the invention be used as a default antenna for data transmission and reception whereas the additional antenna elements are used if needed and terminal configuration allows (for example dependent on the position and orientation of the slide, hinge etc.). Moreover, by using the existing terminal antenna the RF design changes are kept to a minimum which reduces RF redesign costs and re-testing of the terminal. In these embodiments of the invention the only change to the terminal required is that regarding normal (BT/WLAN) data reception and transmission is the addition of a switch to the RF chain. This switch is used to select the existing terminal antenna or the additional array antennas elements.

With respect to FIG. 7, an example of the practical arrangement of the antenna array 209 on an actual user equipment 1 is shown. The user equipment 1 can be clearly shown having the input keypad 2 and the display screen 5. Furthermore the first 209a to fifth 209e antenna elements of an antenna array are shown. The first antenna element 209a is shown located on the right edge of the display 5. The second antenna element 209b is shown located at the top right corner of the display 5. The third antenna element 209c is shown located at the top edge of the display 5. The fourth antenna element 209d is shown located at the top left corner of the display 5. The fifth antenna element 209e is shown located at the left edge of the display 5. Each antenna element 209 is shown with different orientations to each other. Thus the first antenna element 209a is orientated 0-180 degrees, where 0 degrees indicates a general up direction for a normal operation of the user equipment. The second antenna element 209b is orientated approximately at 315-135 degrees, the third antenna element 209c is orientated approximately at 270-90 degrees, the fourth antenna element 209d is orientated approximately at 225-45 degrees and the fifth antenna element 209e is orientated at 180-0 degrees.

The antenna elements 209 each can be seen to be formed from a pair of monopole antenna elements. For example the first antenna element 209a has a first monopole 501, a second monopole 503 and a connecting element 505. These antenna element dipole arrangements may be implemented on the user equipment 1 and each may be integrated as a single ceramic component on the body of the user equipment 1.

In some embodiments of the invention the antenna elements integrated on ceramic components may also incorporate the balun elements described below on the same ceramic structure. In other embodiments a single-ended antenna with radiation properties resembling the properties of a balanced antenna may also be used.

As would be understood by the person skilled in the art the antenna elements may be located elsewhere on the user equipment at suitable locations and orientations in order to provide sufficient antenna element separation and transmission/reception coverage.

With respect to FIGS. 8 to 13, some circuitry schematics of embodiments of the invention are shown. With respect to FIGS. 8 and 9 embodiments capable of implementing a balanced feed line pair connection between the transceiver and the RF front end are described. With respect to FIGS. 10 and 11 embodiments capable of implementing both a balanced feed line pair and an unbalanced feed line between the transceiver and the RF front end are described. With respect to FIGS. 12 and 13 embodiments capable of implementing unbalanced feed line communication between the transceiver and the RF front end are described.

Where similar elements as described previously are shown the same reference numbers are kept.

With respect to FIG. 8, an embodiment of the invention implementing separate transmission path and reception path balanced feed line pair connection between the transceiver and the RF front end is described.

The antenna array 209 is shown connected via a serried of balanced feed line pair connections 207 to RF front end and specifically the antenna selection switch 601.

The antenna selection switch 601 is configured to be controlled from a control signal received from the transceiver 201 via the antenna switch control feed 205b. The antenna selection switch 601 may comprise a pair of switches configured to connect the balanced feed from at least one of the antenna array elements to the internal balanced feed pair 403 between the antenna selection switch 601 and the receiver/transmitter mode selection and amplification module 603.

The receiver/transmitter mode selection and amplification module 603 comprises a receiver/transmitter mode selection switch 805 and a amplification module 811. The amplification module 811 comprises a differential power amplifier 807 for amplifying signals to be transmitted and a differential low noise amplifier 809 for amplifying signals received. The internal balanced feed pair 403 is connected to one end of the receiver/transmitter mode selection switch 805 and dependent on the receiver/transmitter mode control signal received from the transceiver via the receiver/transmitter mode control feed 205a connects the other end of the internal balanced feed pair 403 to either the differential input of the low noise amplifier 809 or to the differential output of the differential power amplifier 807. In this way the receiver/transmitter mode selection switch 805 can switch between the transmission and reception pathways.

The differential input of the power amplifier is furthermore connected to a first pair of balanced feed lines. The differential output of the low noise amplifier is connected to a further pair of balanced feed lines. The balanced feed lines (both the first and further pair) 271 connect the RF front end 401 to the transceiver.

The transceiver 201 comprises a radio frequency to baseband converter 611 which comprises a transmitter balun 801, a receiver balun 803, an upconverter 611a and a downconverter 611b.

A balun is a device capable of converting a balanced signal to a unbalance signal and vice versa—in other words capable of converting a single sided signal to a differential signal and a differential signal to a single sided signal. The balun has an unbalanced input/output side and a balanced input/output side. A typical balun configuration would be an autotransformer where the balanced input/output nodes are the two end inputs to the auto-transformer and the unbalanced input/output is taken from one end input of autotransformer. The centre tap of the autotransformer is connected to ground or earth.

The first pair of balanced feed lines are connected to the balanced side of the transmitter balun 801 and the unbalanced side of the transmitter balun 801 is connected to the output of the upconverter 611a.

The upconverter 611a receives the in-phase and quadrature phase modulated symbols and multiplies each by a local oscillator to upconvert the baseband frequency signal to a radio frequency signal. The upconverted radio frequency in-phase and quadrature phase components are then combined and form the input to the unbalanced side of the transmitter balun 801.

Thus the transmission pathway is from the upconverter 611a, to the transmitter balun 801, to the differential power amplifier 807 via the first balanced feed pair 271, to the receiver/transmitter switch 805, to the antenna switch 601 via the internal balanced feed pair 403 if the receiver/transmitter switch 805 is connected, to the antenna array element dependent on the antenna switch 601.

The second pair of balanced feed lines are connected to the balanced side of the receiver balun 803 and the unbalanced side of the receiver balun 803 is connected to the input of the down converter 611b.

The down converter 611b receives the unbalanced radio frequency signal from the receiver balun 803 and splits the signal into in-phase and quadrature phase components and multiplies each by a local oscillator to down convert the radio frequency signals to baseband frequency in-phase and quadrature signal components.

Thus the reception pathway is from the antenna element 209 to the antenna selection switch via the balanced feed pair 207, to the receiver/transmitter switch 805 via the internal balanced feed pair 403, to the differential low noise amplifier 809 if the receiver/transmitter switch is connected, to the receiver balun 803 via the further balanced feed pair 271, to the down converter 611b.

The embodiment of the invention shown in FIG. 8 and described above improves upon the prior art as it uses a less complex design which only required a single pair of baluns instead of a balun for each antenna element as used in the prior art.

Furthermore by amplifying at a point close to the antenna array for example within the radio frequency front-end 401 (the differential power amplifier 807 and differential low noise amplifier 809) the problems of attenuation and noise accumulation caused by the non-optimal interconnections used in user equipment, such as FLEX, can be at least mitigated partially. FLEX cables are flexible interconnect cables similar in appearance as ribbon cable.

In some embodiments of the invention the receiver/transmitter mode control signal transmitted on the receiver/transmitter mode control feed 205a not only controls the receiver/transmitter switch 805 but also switches on either the differential power amplifier 807 or the low noise amplifier 809 in order to further conserve power and reduce heat generation. Thus in such embodiments of the invention when the receiver/transmitter mode control signal indicates that the device is transmitting the power amplifier is switched on and the low noise amplifier switched off. Similarly when the receiver/transmitter mode control signal indicates that the device is receiving the low noise amplifier 809 is switched on and the power amplifier 807 is switched off. In these embodiments not only is power consumption reduced but possible cross noise between the transmitter and receiver pathways can be reduced.

Furthermore by implementing the interconnect between the transceiver 201 and RF front end 401 using differential signals it is possible to reduce the accumulated noise on the interconnect 271. This is particularly useful for weakly received signals.

With respect to FIG. 9 a further embodiment is shown. This further embodiment differs from the embodiment shown in FIG. 8 in that the interconnect between the RF front end 401 and transceiver 201 is shared for both the transmission path and the reception path—in a manner shown in FIG. 3.

The structure of FIG. 9 differs from the structure of FIG. 8 by only having a single balanced feed pair 271 between the RF front end 401 and the transceiver 201. The transceiver thus further has a transceiver receiver/transmitter switch 907 which is configured to connect the single balanced feed pair 271 to either the balanced side of the transmitter balun 801 or the balanced side of the receiver balun 803. The switch is controlled by the receiver/transmitter mode control signal received from the receiver/transmitter mode control feed 205a

The receiver/transmitter mode selection and amplification module 603 further comprises a further receiver/transmitter mode switch 903 which is configured to connect the signal balanced feed pair 271 to either the differential input of the differential power amplifier 807 or the differential output of the differential low noise amplifier 809 dependent on the receiver/transmitter mode control signal received from the receiver/transmitter mode control feed 205a.

In this embodiment of the invention there are fewer radio frequency feeds required at the expense of a couple of switches.

With respect to FIG. 10 a further embodiment of the invention is shown wherein the power amplifier 605 of the amplification module 811 is implemented in a single end or unbalanced form and the low noise amplifier 809 implemented in a differential form.

In such an embodiment of the invention the difference between the embodiment shown in FIG. 10 and the embodiment shown in FIG. 8 is that the transmitter balun 801 is moved from the transceiver 201 to the RF front end 401. Thus the transmitter balun 801 balanced end is connected to the receiver/transmitter mode selection switch 805 (at the receiver/transmitter mode selection switch 805 transmit path terminals) and the unbalanced end is connected the output of the single ended power amplifier 605. The input to single ended power amplifier 605 is connected to a unbalanced feed 301 to the output of the upconverter 611a.

Thus there is both an unbalanced feed 301 suitable for passing signals from the upconverter 611a to the input of the single ended power amplifier 605 and a balanced feed pair 303 suitable for passing signals from the differential output of the differential low noise amplifier 809 to the receiver balun 803.

In this embodiment of the invention the transmit path is therefore implemented using a single ended implementation and the received path is implemented using a differential implementation. This hybrid solution produces advantages in terms of less complex interconnect configuration compared with the full differential interconnect approach and does not decrease the performance of the device as typically the transmit path is less sensitive to noise than the receive path.

With respect to FIG. 11, a further embodiment of the invention is shown wherein a receiver transmitter mode selection switch is inserted both within the received transmitter mode selector and amplification module 603 and the phone hardware. Thus a receiver/transmitter mode selection switch 903 is inserted so that the interconnect 905 is connected either to the single ended power amplifier input or the differential output of the low noise amplifier 809. The interconnect 905 is at the other end connected to the receiver/transmitter switch 907 such that it is connected to the single ended up converter 611 of the radio frequency bass band converter 611 or connected to the differential or balanced input of the balun 803 of the radio frequency bass band converter 611. In such an embodiment of the invention once again the number of interconnect required between the phone hardware 653 and the antenna module 651 is reduced.

With respect to FIGS. 12 and 13, a full single ended implementation embodiment is shown. Specifically the embodiment shown in FIG. 12 has both a power amplifier 605 of the amplification module 811 implemented in a single end or unbalanced form and the low noise amplifier 809 implemented in a single end form. As described previously the implementation of the single ended low noise amplifier allows the reconfiguration of the circuit so that the receiver balun may be moved to lie between the receiver/transmitter mode selection switch and the single ended low noise amplifier in the same manner that the transmitter balun is moved with the introduction of the single ended power amplifier as described previously with respect to FIG. 12. Furthermore the connection from the amplifier module and the transceiver 201 may be implemented by a pair of unbalanced feed lines—a transmitter unbalanced feed line 311 connecting the upconverter 611a to the input of the single ended power amplifier 605 and a receiver unbalanced feed line 311 connecting the output of the single ended low noise amplifier 607 to the downconverter 611b.

In such an embodiment of the invention, it is possible to further simplify the configuration of the circuit by reordering the baluns and the receiver/transmitter mode switch so that a single balun converts both the receiver and transmitter differential to single ended conversions. In this configuration the output of the antenna selection switch is input to a balanced balun 897 and the unbalanced end of the balun is connected to the input of a single ended receiver/transmitter mode switch 899. The other end of the single ended receiver/transmitter mode switch 899 being connected to either the single end output of the single ended power amplifier 605 or the single ended input of the single ended low noise amplifier 607. This configuration requires only one balun 897 as it is used in both the common (transmission and reception) path located after the receiver/transmitter mode switch 899.

In this embodiment of the invention both transmit and receive paths are largely therefore implemented using a single ended implementation. This embodiment produces advantages in terms of less complex interconnect configuration compared with both full differential and hybrid interconnect approach.

With respect to FIG. 13, a further embodiment of the invention is shown wherein the unbalanced or single ended interconnects between the RF front end 401 and the transceiver are combined to form a single unbalanced feed line 381 which is used for both transmitting and receiving data. To carry out this combination the RF front end has a further single ended receiver/transmitter mode selection switch 901 configured to receive the output from the single ended low noise amplifier 607 and the input from the single ended power amplifier 605 and connect one of these to one end of the single unbalanced feed line 381.

The transceiver has a similar single ended receiver/transmitter mode selection switch 903 configured to connect the other end of the single unbalanced feed line 381 to either the downconverter 611b when the device is in receive mode or to the upconverter 611a when the device is in transmit mode.

Both of these receiver/transmitter mode selection switches may be controlled by the receiver/transmitter mode control signal from the receiver/transmitter mode control feed 205a. In such an embodiment of the invention once again the number of interconnects required between the transceiver 201 and the radio frequency front end is reduced.

With respect to FIG. 14, an embodiment of the invention is shown which shows in further detail the second part of the radio frequency front end 1503 shown in FIG. 6. The figure shows clearly where the complexity of the device according to embodiments of the invention is simplified when compared to the prior art.

The transceiver 201 outputs radio frequency signals to be transmitted on the RF outline 311 and furthermore receives radio frequency signals on the RF inline 309. Furthermore the transceiver outputs a control signal in regards to a receiver/transmitter mode control signal on a transmitter_on line 205a. The transmitted_on line is the equivalent to the receiver/transmitter mode control feed 205a shown in FIG. 12.

The transmitter furthermore transmits a reset and enable signal on the reset and enable line 1311 to the first part of the RF front end 1503. The clock generator 1501 furthermore is connected to the first part of the RF front end 1503 and the transceiver 201 providing a clock signal to enable synchronisation operations.

The first part of the RF front end 1503 comprises a clock divider 1301 which receives the clock signal from the clock generator 1501 and outputs a divided clock value, in other words a clock signal edge is at a lower frequency than the original clock value, to the counter 1305 and the state machine 1303.

The state machine 1303 receives the clock signal from the clock divider 1301 and also receives a reset and enable signal via the reset and enable line 1311 from the transceiver 201. The state machine 1303 controls the selection of reception or transmission to either the normal transmit/receive antenna for communication or transmit receive antenna elements for direction finding.

The state machine 1303 is explained in further detail with respect to FIG. 18. The state machine operates according to one of three different states. The first state defines a “select the first antenna” state 1701, the second state operates as a “go to next” state 1703 and the third state operates a “stay at current” state 1705.

The state machine examines the value of the current state and also of the value of the reset and enable signal from the transceiver 201 on every cycle of the clock signal received from the clock divider 1301.

If we start at the “select the first antenna” state 1701, the reset signal is set at 1 and the enable signal is set at 0. If at the next clock signal the reset and enable are both at 0 then the operation passes to a “stay at current” state 1705. If starting at the “select the first antenna” state 1701 the reset and enable values equal 1, in other words the operation is enabled, the state machine moves to the “go to next” state 1703.

Starting from the “go to next” state 1703, if the reset and enable input is equal to 0 at the next clock cycle then the state machine moves to a “stay at current” state 1705. If the reset and enable signal is equal to 1 the state machine stays at the “go to next” state 1703.

Starting at the “stay at current” state 1705, if the state machine receives a reset and enable signal of equal to 0 at the next clock cycle, then the state machine stays at the “stay at current” state 1705. If the state machine receives a reset and enable signal of equal to 1, the state machine moves to the “select the first antenna” state 1701.

The “select the first antenna” state outputs a reset value of equal to 1 and an enable output of equal to 0 to the counter 1305. The “go to next” state 1701 outputs an enable value of equal to 1 and a reset value of equal to 0 to the counter 1705. The “stay at current” state 1705 outputs an enable value of 0 and a reset value of 0 to the counter 1305.

The counter 1305 receives a reset value and an enable value from the state machine. The counter furthermore receives a clock signal from the clock divider 1301. The frequency of the clock signal from the clock divider 1301 may be different clock signal frequency received by the state machine from the clock divider 1301.

The counter 1305 resets the value of the counter where there is a reset value of equal to 1 on receiving a trigger of the clock edge or level from the clock divider 1301. The counter 1305 furthermore increments the counter value on receiving an enable value of equal to 1 while not receiving a reset value equal to 1 and receiving a clock signal from the clock divider 1301. The counter 1305 on receiving an enable signal equal to 0 and a reset signal equal to 0 does not do anything on receiving the clock signal from the clock divider 1301.

In other words the “select the first antenna” state 1701 causes the counter to reset and therefore select the first antenna, the “go to next” state causes the counter to increment and the “stay at current” causes the counter to stay at its current value.

The counter 1305 outputs the value of the counter, which is a switch control signal value, to the antenna selection switch 601 or the second part of the RF front end 1505. Furthermore the counter 1305 outputs the counter value to the control logic 1307.

The control logic 1307 receives the output of the counter in the form of the switch control signal value n, and the transmitter/receiver mode selection signal, tx_on, from the transceiver 201. The control logic 1307 outputs a 1 value to the array/main antenna switch 1309 if the tx_on signal is equal to 1 and the switch control signal is equal to 0.

The radio frequency output signal received via the RF output and balanced feed 311 is input to the input of the power amplifier 605 of the output of the power amplifier 605 connects to the ‘1’ or first selection node of the transmitter/receiver mode selection switch 899. The radio frequency input to the transceiver 201 is received via the receiver feed 309 which connected to the ‘0’ or second selection node of the receiver/transmitter mode selection switch 899. The common node of the receiver/transmitter mode selection switch 899 is connected to the common node of the array/main antenna switch 1309. The ‘1’ or first selection node of the array/main antenna switch 1309 is connected to the balanced or unbalanced feed line 263 which is connected to the existing terminal antenna, such as the one which may be used for connection to the access network.

The ‘0’ or second selection node of the array/main antenna switch 1309 is connected to the unbalanced side of the balun 897. The balanced side of the balun 897 is connected to the balanced feed 1507 to connect to the second part of the radio frequency front end 1505. With respect to FIGS. 15, 16 and 17 a series of arrangements of antenna selection switches are shown. With respect to FIG. 15, the radio frequency front end second part 1505 is shown with the antenna selection switch 601. The antenna selection switch receives the radio frequency balanced feeds from the balun 897. Furthermore the antenna selection switch shows having received a switch control signal from the counter or switch control logic 1305. The connection between the switch control logic 1305 and the antenna selection switch 601 is such that it requires at least log₂N pins (where N is the number of antenna elements used) or connections in order to transfer the switch control signal capable of selecting any one of the N possible selections.

The value of the switch control signal controls the selection carried out by the antenna selection switch 601. Thus when the counter outputs the switch control signal value of 0 the first antenna of the antenna's selectable by the antenna selection switch is selected and when the switch control signal value of n is equal to the highest number of the antenna selectable via the antenna selection switch 601, the antenna with the highest value is selected. In some embodiments of the invention the switch control signal value of 0 controls the antenna selection switch to switch to a transmit and receive cellular communication antenna such as a 3GPP, GPRS or GSM transmit and receive antenna and a switch control signal value of 1 to the maximum defined value selects one from a selection of lower power antennas—such as a Bluetooth antenna element.

With respect to FIG. 16 a similar arrangement to that shown in FIG. 15 is shown. However in this embodiment the number of connections/pins between the first and second parts of the RF front end parts can be significantly reduced. transferring only the clock signal and a reset and enable signal to the second part of the RF front end rather than the switch control signal value and then implementing the timing logic and counter (switch control logic) in the second part of the radio frequency front end 1505.

Thus the clock generator 1501 supplies a clock signal to both the timing logic 1607, which carried out a process similar to that of the state machine, however, it receives a reset signal from baseband circuitry 1601 or the first part of the radio frequency front end 1503. The baseband circuitry 1601 provides a reset and enable signal to the timing logic circuitry enabling a similar state logic to be carried out as described above. The timing logic supplies the enable signal to the switch control logic (counter) 1605 to enable it to increment the counter value and thus provide a switch control signal value to the antenna selection switch 601.

The output of the switch control logic (counter) 1605 is passed to the antenna selection switch 601 and the antenna selection switch carries out the selection similar to that shown and described with regards to FIG. 15.

With respect to FIG. 17 a serial with internal clock implementation of the antenna selection switch is shown. In this embodiment the number of connections/pins between the first and second parts of the RF front end parts has been even further reduced in that only a reset and a clock signal is passed to the second part of the RF front end from the first part of the RF front end. In this embodiment of the invention the antenna selection switch 601 receives the counter value from the switch control logic (counter) 1701 implemented within the radio frequency front end second part 1505. The switch control logic (counter) 1701 receives both the clock and the reset signal from baseband circuitry 1703 which is contained within the first part of the radio frequency front end 1503.

The baseband circuitry 1703 thus outputs a switch antenna signal, which is received by the switch control logic 1701 as a clock signal, and a start count signal which is received as a reset signal by the switch control logic. The switch control logic (counter) 1701 is triggered internally. Thus the switch antenna signal operates as a clock signal for the counter, or in other words the switch control logic 1701 increases its own internal counter value on the receipt of an edge of the switch antenna signal.

Thus in summary the embodiments of the invention reduce the complexity of the circuitry used in the conventional communications device apparatus which also requires use of a secondary antenna array for doing radio directional finding. Furthermore as can be seen in some of the embodiments not only can the circuitry be shared with regards to the configuration and selection circuitry but in some embodiments of the invention the antenna element may be shared among data communication and direction data. Furthermore in some embodiments further simplification can lead to less inter connections being required within the apparatus.

It is noted that whilst embodiments have been described in relation to mobile devices such as mobile terminals, embodiments of the present invention are applicable to any other suitable type of apparatus suitable for communication via access systems. A mobile device may be configured to enable use of different access technologies, for example, based on an appropriate multi-radio implementation.

FIGS. 19 to 22 show further embodiments of the invention implemented within apparatus as shown in FIGS. 1 and 2. Although the following implementations are described with respect to a first wireless communications system being a Bluetooth standard location enabled system and a second wireless communications system being a wireless local area network (WLAN) communications system it would be understood that the first and second communications systems may be any suitable wireless communications format system which may include cellular communications systems (such as any 3GPP standard related system, or IEEE wireless communications standard systems).

FIG. 19a shows a schematic apparatus implementation view which may be employed as part of a slider or clam-shell mobile communications device where a first part of the mobile communications device shown to the left of the dividing line 1925 may contain the Bluetooth or low power transmitter/receiver array and switch module and the second part of the mobile communications device shown to the right of the dividing line 1925 comprises an antenna RF switch, low power transceiver, and wireless communications transceiver and associated front end module and antenna. The RF connector 1993, RF control switch connector 1997 and RF switch control connector 1995 may be routed through or round the clam-shell format hinges or the slider format sliders 1991.

The apparatus may comprise a plurality of Bluetooth antennas which may be used for location or space division multiplexing purposes. In the example shown in FIG. 19 four Bluetooth antennas 209b, 209c, 209d and 209e are shown. However in embodiments of the invention any suitable number of antennas may be used. Each of the Bluetooth antennas 209 may be a dipole antenna as shown and described with respect to the FIGS. 2 to 7 or each may be, in other embodiments, a single-ended antenna.

The antennas may be connected to the array radio frequency switch module 1901. The array radio frequency switch module 1901 may comprise a control logic module 1951 the operation and organisation of which is described later. The array radio frequency switch module 1901 may receive a voltage supply input for powering the control logic module 1951.

The array radio frequency switch module 1901 furthermore may receive (via contacts in hinges or sliders or other connections) a radio frequency connection 1993. The radio frequency connection 1993 may be configured to transmit and receive the radio frequency signals between the array radio frequency switch module 1901 and an antenna radio frequency switch 1903.

The array radio frequency switch module 1901 may receive via the radio frequency switch control connection 1995 a radio frequency switch control signal which may be input directly to the control logic module 1951.

The control logic module 1951 (and thus the array radio frequency switch module 1901) may further output via the antenna radio frequency switch control connector 1997 an antenna radio frequency switch control signal to the antenna radio frequency switch 1903.

The configuration and operation of the array radio frequency switch module 1901 is shown in further detail with respect to FIG. 21a.

The array radio frequency switch module 1901 as well as comprising the control logic module 1951 (as shown in FIG. 19a), also comprises a single pole four throw (SP4T) radio frequency switch 2101. The single pole four throw radio frequency switch 2101 may be configured so that a pole contact may be connected to the radio frequency connection 1993 between the array radio frequency switch module 1901 and the antenna radio frequency switch 1903. Each of the throw contacts of the SP4T switch 2101 may be connected to an associated antenna input (or in some embodiments an associated balun unbalanced input). For example a first throw contact may be connected to the first antenna 209b, a second throw contact may be connected to the second antenna 209c, a third throw contact may be connected to the third antenna 209d and a fourth throw contact may be connected to the fourth antenna 209e. The SP4T switch 2101 may therefore enable a connection via the associated antenna 209 for the transmission and reception of radio frequency signals. The SP4T switch 2101 may be an aborptive type switch. Furthermore in embodiments of the invention the SP4T switch 2101 may be configured to conduct in the ISM band, have insertion losses less than 1 dB, maintain isolation greater than 20 dB, and have a switching time of about 100 ns.

The SP4T radio frequency switch 2101 may be controlled by the control logic module 1951 wherein the control logic module makes or breaks the contacts between the pole and the contacts. The control logic module may comprise drivers 2151 configured to drive the SP4T radio frequency switch 2101. The drivers may also provided a further signal via the antenna RF switch control connector 1997 to the antenna RF switch 1903 for driving the antenna RF switch 1903.

The drivers 2151 may further be controlled by a RF switch control signal received via the RF switch control connector 1995 from the location enabled transceiver 1907. The RF switch control signal may control the driver to selectively drive at least one of the SP4T RF switch 2101 or the antenna RF Switch 1903.

The drivers 2151 may also receive a further two bit input signals from the control signal multiplexer 2153. The further two bit input signals may control the drivers 2151 to drive one of the four connections between the pole and an associated connection of the SP4T switch 2101.

The control signal multiplexer 2153 may be a 4-to-2 multiplexer with a first set of inputs from a two-bit counter 2155, a second set of inputs set to a logical or physical zero value, and a control input configured to select either of the first set of inputs or the second set of inputs from the radio frequency switch control connection 1995. The control signal multiplexer 2153 may be configured so that when the radio frequency switch control signal provides a logical or physical “1” signal the multiplexer outputs the two bit counter value to the drivers 2151 whereas when the radio frequency switch control signal has a logical or physical “0” value the multiplexer outputs the logical or physical zero value to the drivers 2151.

The two bit counter 2155 may be incremented on receiving a clock signal or may be incremented on receiving the RF switch control signal. Thus in some embodiments of the invention the counter may increment on the falling edge of the RF switch control signal. The two bit counter 2155 may further be reset on receiving a suitable reset signal.

The antenna radio frequency switch 1903 may be configured to receive and transmit radio frequency signals via the radio frequency connection 1993 to the array radio frequency switch module 1901. Furthermore the antenna radio frequency switch 1903 may be configured to receive antenna radio frequency switch control signals via the antenna radio frequency switch connection 1997. The antenna radio frequency switch 1903 furthermore may be connected to the wireless local area network (WLAN) front end module 1905 by a further radio frequency connection 1981. The antenna radio frequency switch 1903 may further be connected to the filter 1913 via a second further radio frequency connection 1983.

The structure of the antenna RF switch 1903 is shown in further detail in FIG. 21b. In FIG. 21b the antenna RF switch is shown as single pole 2 throw (SP2T) switch. The SP2T switch may be an aborptive type switch. Furthermore in embodiments of the invention the SP2T switch may be configured to conduct in the ISM band, have insertion losses less than 1 dB, maintain isolation greater than 20 dB, and have a switching time of about 100 ns.

As shown in FIG. 21b a pole contact may be connected to the second further frequency connector 1983 (which is in turn connected to the filter bank 1913). Similarly the SP2T switch may be configured with a first throw contact connected to the array radio frequency switch module 1901 via the radio frequency connection 1993 and a second throw contact connected to the wireless local area network front end module 1905 via the further radio frequency connector 1981. As described above the switch control signal may be provided from the array radio frequency switch module 1901 via the antenna RF switch control connection 1997.

The filter bank 1913 may be further connected by a third further RF connector 1984 to the location enabled transceiver 1907 and be configured to filter signals passing between the antenna RF switch 1903 and the location enabled transceiver 1907.

The location enabled transceiver 1907 may perform location enhanced dual mode Bluetooth transceiver operations such as those described previously and furthermore may provide the radio frequency switch control signal via the radio frequency switch control connection 1995 to the array radio frequency switch module 1901. The location enabled transceiver 1907 may thus in embodiments of the invention be considered to be the controller controlling the selection of the antennas—as will be shown with respect to FIG. 22 later. To provide the radio frequency switch control signal the location enabled transceiver may further be configured to operate a control process, In other embodiments of the invention the control process may be configured to configure logic in the form of the drivers 2151 in the array RF switch module 1901 to control the generation of the antenna RF switch control signal. Thus in embodiments of the invention the logic within the drivers may be configured to output a logical ‘0’ output for the antenna RF switch control signal when the RF switch control signal has a logical ‘0’ value and a logical ‘1’ output when the RF switch control signal has a logical ‘1’ value. However in other embodiments of the invention other logical configurations may be controlled and may be dependent on the 2-bit counter 2155 output.

The location enabled transceiver 1907 may further communicate via further connections to the wireless local area network transceiver and front end module 1905 via a connector 1911. Communications may be controlled in embodiments of the invention using a packet traffic arbitrator.

The wireless local area network (WLAN) transceiver and front end module 1905 may perform suitable wireless local area network operations such as controlling the communication of control data and traffic data with other WLAN devices (not shown). The WLAN transceiver and front end module 1905 may in some embodiments be two separate modules which may be connected via a transmission (tx) and reception (rx) connection and a control connection.

The wireless local area network transceiver and front end module (WLAN FEM) 1905 may be connected via a radio frequency connection 263 to a ‘primary’ or ‘existing’ antenna configured to transmit and receive Bluetooth/wireless local area network frequencies. As described previously in the application the ‘existing’ antenna 261 may be a Planar Inverted F-type Antenna (PIFA), an Inverted F-type antenna (IFA) configuration, a chip monopole or any suitable antenna.

FIG. 19b shows a further embodiment configuration similar to that shown in FIG. 19a with the following differences.

The antenna RF switch 1903 may be configured so that rather than having a second throw contact connected to the wireless local area network front end module 1905 via the further radio frequency connector 1981 the second throw contact may be connected to the primary’ or ‘existing’ antenna configured to transmit and receive Bluetooth/wireless local area network frequencies via a connector 1945. Furthermore antenna RF switch may be configured so that rather than the pole contact connected to the second further frequency connector 1983 which is in turn connected to the filter bank 1913) the pole contact is connected to the WLAN transceiver and FEM via a RF connection 1982.

Also the Location enabled transceiver 1907 is configured to be connected to the antenna RF switch 1903 via the WLAN transceiver and FEM 1905. In other words the WLAN transceiver and FEM may allow the location enabled transceiver 1907 signals to pass to the RF connection 1982 or may pass the WLAN transceiver and FEM signals to the antenna RF switch 1903.

Thus in these embodiments both the location enabled transceiver signals and the WLAN transceiver signals are able to be connected to either one of the ‘secondary’ antennas 209 configured to transmit and receive Bluetooth/wireless local area network frequencies or the ‘primary’ or ‘existing’ antenna 261 also configured to transmit and receive Bluetooth/wireless local area network frequencies. Thus in embodiments of the invention both communication protocol signals may exploit the diversity gain from accessing different antennas in various locations about the apparatus.

FIG. 20a shows a schematic apparatus implementation view which may be employed as part of a candy bar format mobile communications device with similar separate Bluetooth or low power transmitter/receiver array and wireless communications antenna. These embodiments are similar to the embodiments described in relation to FIG. 19a except that these embodiments show the removal of the antenna radio frequency switch 1903 and one of the Bluetooth antenna (and in some embodiments also the antenna's associated balun). In the embodiments shown with respect to FIG. 20a the SP4T RF switch pole contact may be connected to the location enabled transceiver 1907 via a RF connection 2001. Similarly the throw contact freed by the removal of one of the Bluetooth antenna (and associated balun in a balanced antenna embodiment) may be connected to the WLAN transceiver and FEM 1905 to enable the location enabled transceiver to connect to the BT/LAN antenna 261 via the array RF Switch module 1901, the WLAN transceiver and FEM 1905 and RF connections 2003 and 263.

These embodiments result in a simpler arrangement of components and are capable of similar performance to the above embodiments but at a lower cost.

FIG. 20b shows a further embodiment configuration similar to that shown in FIG. 20a with differences so that the throw contact freed by the removal of one of the Bluetooth antenna is now connected to the BT/LAN antenna 261 via a RF connector 2005 and the WLAN transceiver and FEM 1905 is inserted in the path between the location enabled transceiver 1907 and the SP4T RF switch pole contact. Therefore in these embodiments RF connection 2007 may connect the Location enabled transceiver 1907 and the WLAN transceiver and FEM 1905. Furthermore RF connection 2003 may connect the WLAN transceiver and FEM 1905 with the SP4T RF switch pole contact. This configuration may produce improvements in line with those associated with the embodiments described with reference to FIG. 19b in that both transceivers may access both antenna groups.

It would be appreciated that although the ‘existing’ antenna 261 may be a Planar Inverted F-type Antenna (PIFA), an Inverted F-type antenna (IFA) configuration, a chip monopole or any suitable antenna it may also be an antenna array from which one antenna element from the array or set may be selected.

With respect to FIG. 22 a switch control logic operation and the resultant progression of selected antennas for the 1 RF switch embodiments (shown in FIG. 20) and the 2 RF switch embodiments (shown in FIG. 19) is shown.

The first waveform 2201 shows the logical or physical values for the radio frequency switch control signal. This signal may, as described above, be passed from the location enabled transceiver 1907 to the array radio frequency switch module 1901. This signal is shown alternating between a high physical value (logical value) and a low physical value (logical ‘0’ value) for neighbouring time periods.

The second waveform 2203 shows, for the 2 RF switch embodiments—in other words for the embodiments described with respect to FIG. 19, the antenna switch control signal output from the drivers 2151. In these examples the signal values for the antenna control signal similar to the radio frequency switch control signal in that when the antenna switch control signal is a high voltage level (logical ‘1’ value) the radio frequency switch control signal is also a high voltage level (logical ‘1’ value), and when the antenna switch control signal is a low voltage level (logical ‘0’ value) the radio frequency switch control signal is a low voltage level (logical ‘0’ value).

FIG. 22 shows four complete cycles and one partial cycle for both the RF switch control signal and the antenna switch control signal. The partial cycle T0 2200 before the first complete cycle has a low physical values for both the RF switch control signal and the antenna switch control signal. The first 2211, second 2213, third 2215, and fourth 2217 cycles may be further divided into a first high voltage level part 2211a, 2213a, 2215a, and 2217a, and a second low voltage part 2211b, 2213b, 2215b, and 2217b.

As described above the 2-bit counter 2155 is configured to increment on the falling edge of the RF switch control signal. The third wave-form shows the value of the 2 bit counter starting from a zero value for the partial cycle 2210 and the first part of the first cycle 2211a, a ‘1’ value for the second part of the first cycle 2211b and the first part of the second cycle 2213a, a ‘2’ value for the second part of the second cycle 2213b and the first part of the third cycle 2215a, a ‘3’ value for the second part of the third cycle 2215b and the first part of the fourth cycle 2217a, and returning to a ‘0’ value for the second part of the fourth cycle 2217b.

The fourth waveform 2205 shows the value output by the multiplexer 2153. As described previously the multiplexer may be configured to output the value of the counter when the RF switch control signal is a logical ‘1’ value and output a ‘0’ value when the RF switch control signal is a logical ‘0’ value. Therefore in these embodiments of the invention the partial cycle 2210 and the second parts of the first, second, third and fourth cycles may all output a ‘0’ value, the first part of the first cycle may output a ‘0’ value, the first part of the second cycle may output a ‘1’ value, the first part of the third cycle may output a ‘2’ value, and the first part of the fourth cycle may output a ‘3’ value.

In the fifth waveform 2207 the resultant antenna switching is shown where there are 2 RF switches—as shown in FIG. 19. In such embodiments as described above when the antenna switch control signal has a low physical level (‘0’ logical value) the SP2T switch is configured to connect the location enabled transceiver via the filter bank 1913 to the wireless local area network front end module 1905 to establish a connection between the Bluetooth/wireless local area network antenna 261 and the location enabled transceiver 1907.

Therefore as can be seen in the fifth waveform 2207 for the partial cycle 2210 and each second part of the first 2211b, second 2213b, third 2215b, and fourth 2217b cycles the default antenna (‘D’) otherwise known as the existing or primary antenna may be selected.

Furthermore when the antenna switch control signal has a high physical level (‘1’ logical value) the SP2T switch is configured to connect the location enabled transceiver via the filter bank 1913 to the array RF switch module 1901. Furthermore the SP4T frequency switch 2101 of the array radio frequency switch module is configured to select the contact associated with the counter value when the antenna switch control signal has a high physical level (‘1’ logical value).

Therefore as can be seen in the fifth waveform 2207 for the first part of the first cycle 2211a the ‘0’th Bluetooth antenna 209b may be selected, for the first part of the second cycle 2213a a ‘1’st Bluetooth antenna 209c may be selected, for the first part of the third cycle 2215a a ‘2’nd Bluetooth antenna 209d may be selected, and for the first part of the fourth cycle 2217a a ‘3’rd Bluetooth antenna 209e may be selected.

In other words the embodiments described above show how the directional antennas may be configured to be selected to enable RF signals to be transmitted using the primary or default antenna and the secondary or Bluetooth antennas more efficiently and using fewer components than has been achieved previously.

In the sixth waveform 2209 the resultant antenna switching is shown where there is one RF switch—as shown in FIG. 20. In such embodiments as described above when the antenna switch control signal has a low physical level (‘0’ logical value) the multiplexer 2153 is configured to connect the location enabled transceiver via the filter bank 1913 to the wireless local area network front end module 1905 to establish a connection between the default, primary or existing antenna 261 and the location enabled transceiver 1907.

Therefore as can be seen in the sixth waveform 2209 for the partial cycle 2210 and each second part of the first 2211b, second 2213b, third 2215b, and fourth 2217b cycles the default antenna (‘0’) otherwise known as the existing or primary antenna may be selected.

Furthermore when the antenna switch control signal has a high physical level (‘1’ logical value) the multiplexer is configured to output the value of the 2-bit counter 2155 and enable the SP4T switch to connect the location enabled transceiver via the filter bank 1913 to the contact associated with the counter value.

Therefore as can be seen in the sixth waveform 2209 for the first part of the first cycle 2211a the ‘0’th or primary/default/existing antenna 261 may be selected, for the first part of the second cycle 2213a a ‘1’st Bluetooth antenna 209b may be selected, for the first part of the third cycle 2215a a ‘2’nd Bluetooth antenna 209c may be selected, and for the first part of the fourth cycle 2217a a ‘3’rd Bluetooth antenna 209d may be selected.

In other words the embodiments described above show how the directional antennas may be configured to be selected to enable RF signals to be transmitted using the primary/default antenna and the secondary/Bluetooth antennas also efficiently.

It is also noted that although certain embodiments were described above by way of example with reference to the exemplifying architectures of certain mobile networks and a wireless local area network, embodiments may be applied to any other suitable forms of communication systems than those illustrated and described herein. It is also noted that the term access system is understood to refer to any access system configured for enabling wireless communication for user accessing applications.

The above described operations may require data processing in the various entities. The data processing may be provided by means of one or more data processors. Similarly various entities described in the above embodiments may be implemented within a single or a plurality of data processing entities and/or data processors. Appropriately adapted computer program code product may be used for implementing the embodiments, when loaded to a computer. The program code product for providing the operation may be stored on and provided by means of a carrier medium such as a carrier disc, card or tape. A possibility is to download the program code product via a data network. Implementation may be provided with appropriate software in a server.

For example the embodiments of the invention may be implemented as a chipset, in other words a series of integrated circuits communicating among each other. The chipset may comprise microprocessors arranged to run code, application specific integrated circuits (ASICs), or programmable digital signal processors for performing the operations described above.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

It is also noted herein that while the above describes exemplifying embodiments of the invention, there are several variations and modifications which may be made to the disclosed solution without departing from the scope of the present invention.

1-32. (canceled)

33. Apparatus comprising:
an antenna switch configured to select at least one antenna; and
a controller configured to control the antenna switch in a first mode of operation wherein the apparatus is configured to communicate with a further apparatus, and a second mode of operation wherein the apparatus is configured to perform a direction finding.

34. The apparatus as claimed in claim 33, further comprising:
a transceiver configured to be connected to the antenna switch and configured to generate output signals and decode input signals.

35. The apparatus as claimed in claim 34, further comprising an antenna array comprising at least two antennas, wherein the controller is configured in the second mode of operation to control the antenna switch to sequentially select each antenna.

36. The apparatus as claimed in claim 35, wherein the controller is configured in the first mode of operation to control the antenna switch to select only one antenna.

37. The apparatus as claimed in claim 36, wherein the controller comprises a counter configured to be connected to the antenna switch and output an antenna selection signal, wherein the antenna switch selects at least one antenna dependent on the antenna selection signal value.

38. The apparatus as claimed in claim 37, wherein the controller further comprises a state machine logic configured to output a count signal to the counter, wherein the counter increments the antenna selection signal value dependent on the count signal.

39. The apparatus as claimed in claim 38, wherein the controller further comprises a state machine logic configured to output a reset signal to the counter, wherein the counter resets the antenna selection signal value dependent on the count signal.

40. The apparatus as claimed in claim 39, wherein the controller is further configured to operate the apparatus in an input only mode, wherein signals are input from the antenna switch to the transceiver, and an output only mode, wherein the signals are output from the transceiver to the antenna switch.

41. The apparatus as claimed in claim 40, wherein the transceiver comprises an amplifier comprising: a low noise amplifier and a power amplifier, wherein the controller is configured to operate the low noise amplifier in the input only mode and operate the power amplifier in the output only mode.

42. The apparatus as claimed in claim 33, wherein the antenna switch comprises at least one of: a balanced antenna switch; and a single ended antenna switch.

43. A method comprising:
selecting at least one antenna for connection with an at least one input and output signal; and
controlling the selecting in a first mode of operation to communicate using the signals, and a second mode of operation to perform a direction finding dependent on the signals.

44. The method as claimed in claim 43, further comprising:
generating output signals; and
decoding input signals.

45. The method as claimed in claim 43, wherein controlling in the second mode of operation controls the selecting to sequentially select each antenna.

46. The method as claimed in claim 43, wherein controlling in the first mode of operation controls the selecting to select only one antenna.

47. The method as claimed in claim 43, wherein the controlling comprises:
counting a number of clock signals; and
outputting an antenna selection signal dependent on the counted number of clock signals, and the selecting comprises selecting the at least one antenna dependent on the antenna selection signal value.

48. The method as claimed in claim 47, wherein the controlling further comprises controlling the counting of the clock signals.

49. The method as claimed in claim 48, wherein the controlling comprises controlling the counting of the clock signals by outputting a reset signal, wherein the counting resets the antenna selection signal dependent on the reset signal value.

50. Apparatus comprising:
a first transceiver configured to generate and receive signals using a first communications protocol;
a second transceiver configured to generate and receive signals using a second communications protocol;
an antenna switch configured to select at least one antenna from at least two antennas for connection to either the first or second transceiver; and
a controller configured to control the antenna switch in a first mode of operation wherein the antenna switch is configured to connect the at least one of the antenna to the first transceiver, and a second mode of operation wherein the antenna switch is configured to select the at least one of the antenna to connect to the second transceiver.

51. The apparatus as claimed in claim 50, wherein the first mode of operation is for communication with a further apparatus,

52. The apparatus as claimed in claim 51 wherein the second mode of operation is for direction finding operations.

53. The apparatus as claimed in claim 52, wherein the antenna switch comprises:
a first antenna switch configured to select one of a first set of antennas; and
a second antenna switch configured to select either the first antenna switch or one of a second set of antennas.
